(19) United States
(12) Patent Application Publication
(10) Pub. No.: US 2013/0219253 A1
(43) Pub. Date: Aug. 22, 2013

(54) Editing systems and methods

(71) Applicant: CHIDOPI CO., LTD., (US)

(72) Inventor: Jason Hung, Taoyuan County (TW)

(73) Assignee: CHIDOPI CO., LTD., Taipei City (TW)

(21) Appl. No.: 13/754,994

(22) Filed: Jan. 31, 2013

(30) Foreign Application Priority Data
Feb. 22, 2012 (TW) 101105801

(51) Int. Cl. G06F 17/24

(52) U.S. Cl. CPC G06F 17/24
USPC 715/202

(57) ABSTRACT

Editing systems and methods to be used in a digital content/e-book editing environment are provided. An editing interface in a use interface (for example, a browser picture) in a development platform structured on a cloud network has a universal interactive component frame. At least one user selects required editing components/editing tools to design e-book content and/or digital content, and various interactive program codes are automatically integrated, thus to efficiently finish the required e-book content and/or digital content. The finished e-book content and/or digital content comprising interactive webpage and/or content is packed into a form of application according to the format of an operating system used for packing, wherein the packed application can be downloaded for use and/or published to a shopping mall of application software.

### BACKGROUND OF THE INVENTION

1. Field of the Invention

The present invention relates generally to editing systems and methods, and more particularly, to editing systems and methods to be used in a digital content/e-book editing environment. At least one user designs e-book content and/or digital content, and packs the finished e-book content and/or digital content comprising interactive webpage and/or content into a form of application according to the format of an operating system used for packing, wherein the packed application can be downloaded for use.

2. Description of the Related Art

A conventional editing platform/editing system can provide functions for users to simply and conveniently create, edit and update their own webpage content. In other words, the features of the current conventional editing technology focus on the creation, editing and update of the webpage content.

Additionally, although some e-book generation platforms are currently available, however, the objective of the platforms is to provide generation of e-books with compound layers and HTML (HyperText Markup Language).

Further, although some e-book editing platforms can provide functions for editing e-book content, however, the objective of the platforms is to provide e-book pages for use in touch-sensitive screens, and arrange sub-regions in the pages, such that users can conveniently operate and design the pages.

In other words, the drawback of the conventional e-book editing platform is that various interactive program codes, such as HTML5, Javascript, CSS, and others cannot be integrated into the editing interfaces. Further, for example, since the platform does not have the universal frame forms for the interactive HTML5 components, no editing-friendly data uploading interface can be provided by using the browser picture.

Also, since the editing interfaces cannot integrate various cool and dazzling interactive program codes, such as HTML5, it is incapable to efficiently finish an interactive webpage or content.

Consequently, for current editing platforms, it is expected to provide, not only in the e-book editing environment but also the digital content environment, an editing interface which can be integrated with various interactive program codes, such as HTML5, Javascript, CSS, and others, and a use interface, such as a browser picture in a development platform structured on a cloud network, wherein the browser picture has a universal interactive component frame and provides an editing-friendly data uploading interface, which can be integrated with various interactive program codes, such as HTML5, Javascript, CSS, and others, thus to efficiently finish the required e-book content and/or digital content. Further, it is expected to provide functions to pack the finished e-book content and/or digital content comprising interactive webpage and/or content into a form of application, wherein the packed application can be downloaded for use.

### BRIEF SUMMARY OF THE INVENTION

The objective of the present invention is to provide an editing system and method to be used in a digital content/e-book editing environment, wherein an editing interface in a use interface, such as a browser picture in a development platform structured on a cloud network has a universal interactive component frame. At least one user selects required editing components/editing tools to design e-book content and/or digital content.

Another objective of the present invention is to provide an editing system and method to be used in a digital content/e-book editing environment, wherein an editing interface in a use interface, such as a browser picture in a development platform structured on a cloud network is integrated with various interactive program codes, such as HTML5, Javascript, CSS, and others, and provides an editing-friendly data uploading interface which can automatically integrated with various cool and dazzling interactive program codes, such as HTML5, Javascript, CSS, and others, thus to efficiently finish the required e-book content and/or digital content.

A further objective of the present invention is to provide an editing system and method to be used in a digital content/e-book editing environment, wherein the finished e-book content and/or digital content comprising interactive webpage and/or content is packed into a form of application according to the format of an operating system used for packing, wherein the packed application can be downloaded for use.

According to above objectives, the present invention provides an editing system comprising an editing processing module and an application database.

The editing processing module presents editing components/editing tools in an editing interface in a use interface, such as a browser picture in a development platform structured on a cloud network, such that at least one user selects the required editing components/editing tools to design e-book content and/or digital content, in which various interactive program codes are automatically integrated therein, thus to efficiently finish the required e-book content and/or digital content. The editing processing module further packs the finished e-book content and/or digital content comprising interactive webpage and/or content into a form of application according to the format of an operating system used for packing, wherein the packed application can be downloaded for use.

The application database can store the packed applications corresponding to the e-book content and/or digital content, wherein the packed application can be downloaded by users for use.

In the procedure of an editing method using the editing system of the present invention, first, at least one user selects required editing components/editing tools to design e-book content and/or digital content using an editing interface in a use interface, such as a browser picture in a development platform structured on a cloud network, in which various interactive program codes are automatically integrated therein, thus to efficiently finish the required e-book content and/or digital content. Here, the editing interface in the browser picture has a universal interactive component frame, and the editing processing module presents the editing components/editing tools in the editing interface in the browser picture on the user side, such that the at least one user selects the required editing components/editing tools to design e-book content and/or digital content, in which various interactive program codes are automatically integrated therein, thus to efficiently finish the required e-book content and/or digital content.

Then, the finished e-book content and/or digital content comprising interactive webpage and/or content is packed into a form of application according to the format of an operating system used for packing, wherein the packed application can be downloaded for use. Here, the editing processing module packs the finished e-book content and/or digital content comprising interactive webpage and/or content into a form of application according to the format of an operating system used for packing, and stores the packed application in the application database 3, wherein the packed application can be downloaded for use and/or published to a shopping mall of application software.

Editing methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a system schematic diagram illustrating the system architecture and operation situations of an editing system of the present invention;

FIG. 2 is a flowchart of procedure steps of an editing method performed by the editing system of the present invention;

FIG. 3 is a system schematic diagram illustrating an embodiment and operation situations of the editing system of the present invention; and

FIG. 4 is a flowchart of procedure steps of an editing method performed by the embodiment of the service system of the present invention in the FIG. 3.

### DETAILED DESCRIPTION OF THE INVENTION

Editing systems and methods are provided.

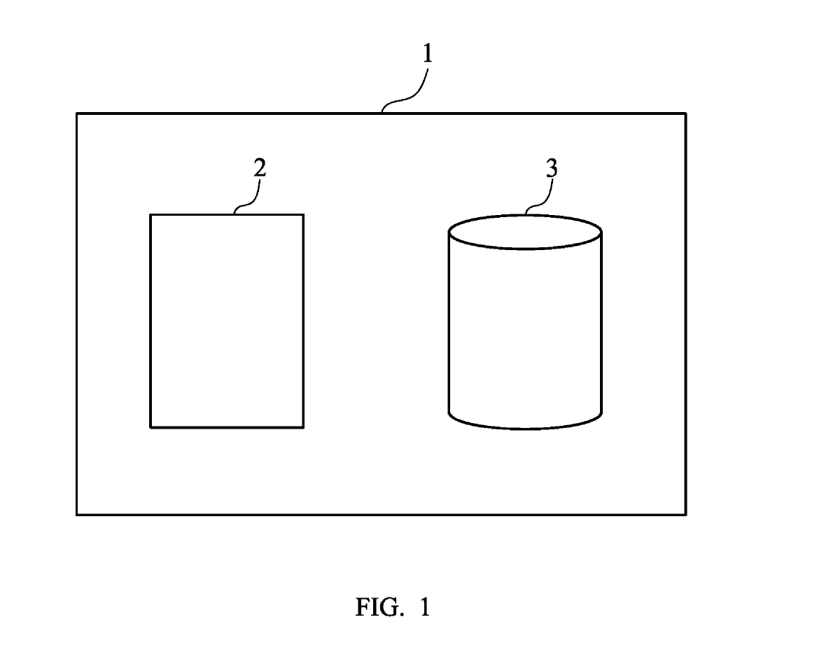

FIG. 1 is a system schematic diagram illustrating the system architecture and operation situations of an editing system of the present invention. As shown in FIG. 1, the editing system 1 comprises an editing processing module 2 and an application database 3.

The editing processing module 2 presents editing components/editing tools (not shown) in an editing interface (not shown) in a use interface, such as a browser picture (not shown) in a development platform structured on a cloud network on the user side (not shown), such that at least one user (not shown) selects the required editing components/editing tools to design e-book content and/or digital content, in which various interactive program codes are automatically integrated therein, thus to efficiently finish the required e-book content and/or digital content. The editing processing module 2 further packs the finished e-book content and/or digital content comprising interactive webpage and/or content into a form of application (not shown) according to the format of an operating system used for packing, wherein the packed application can be downloaded for use.

The application database 3 can store the packed applications corresponding to the e-book content and/or digital content, wherein the packed applications can be downloaded by users for use and/or published to a shopping mall of application software.

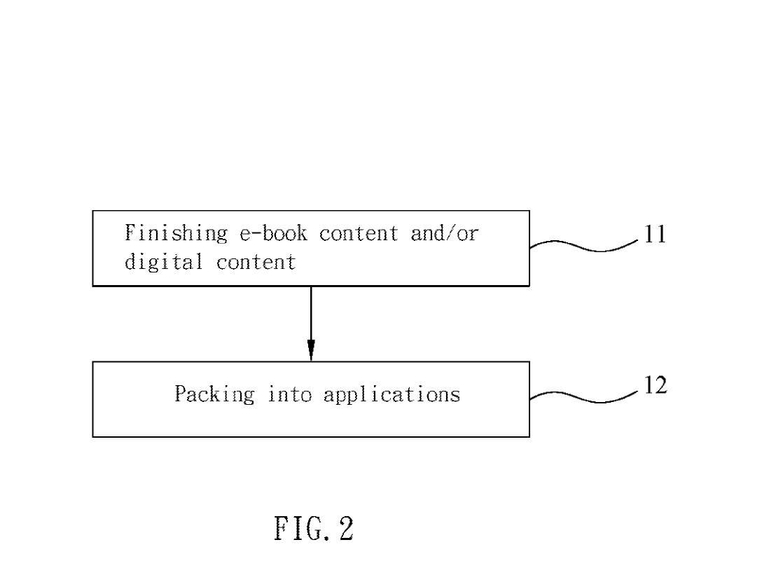

FIG. 2 is a flowchart of procedure steps of an editing method performed by the editing system of the present invention. As shown in FIG. 2, first, in step 11, at least one user selects required editing components/editing tools to design e-book content and/or digital content using an editing interface in a browser picture, in which various interactive program codes are automatically integrated therein, thus to efficiently finish the required e-book content and/or digital content. The procedure goes to step 12. Here, the editing interface in the browser picture has a universal interactive component frame, and the editing processing module 2 presents the editing components/editing tools in the editing interface in the browser picture on the user side, such that the at least one user selects the required editing components/editing tools to design e-book content and/or digital content, in which various interactive program codes are automatically integrated therein, thus to efficiently finish the required e-book content and/or digital content.

Then, in step 12, the finished e-book content and/or digital content comprising interactive webpage and/or content is packed into a form of application according to the format of an operating system used for packing, wherein the packed application can be downloaded for use. Here, the editing processing module packs the finished e-book content and/or digital content comprising interactive webpage and/or content into a form of application according to the format of an operating system used for packing, wherein the packed application can be downloaded for use and/or published to a shopping mall of application software.

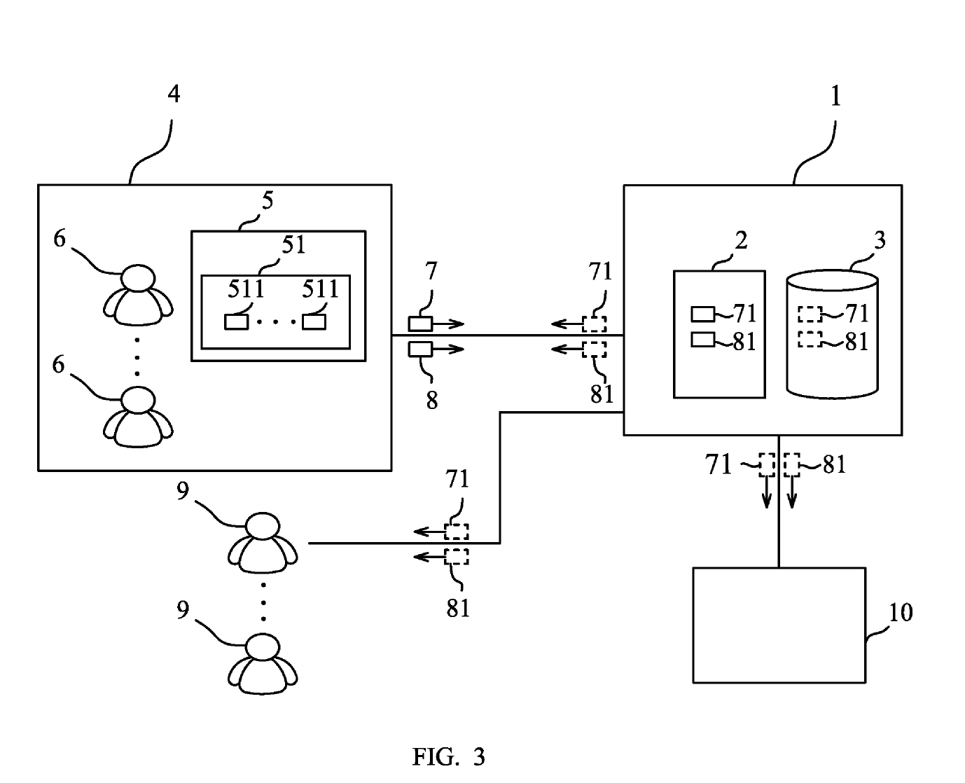

FIG. 3 is a system schematic diagram illustrating an embodiment and operation situations of the editing system of the present invention. As shown in FIG. 3, the editing system 1 comprises an editing processing module 2 and an application database 3.

The editing processing module 2 presents editing components/editing tools 511 in an editing interface 51 in a browser picture 5 (which is a use interface in a development platform structured on a cloud network) on the user side 4, such that at least one user 6 selects the required editing components/editing tools 511 to design e-book content and/or digital content, in which various interactive program codes, such as HTML5, Javascript, CSS, and others are automatically integrated therein, thus to efficiently finish the required e-book content 7 and/or digital content 8. The editing processing module 2 further respectively packs the finished e-book content 7 and/or digital content 8 comprising interactive webpage and/or content into applications 71 and 81 according to the format of an operating system used for packing, wherein the packed applications 71 and 81 can be downloaded for use.

The application database 3 can store the packed applications 71 and 81 corresponding to the e-book content 7 and/or digital content 8, wherein the packed applications 71 and 81 can be downloaded by user 6 or user 9 for use and/or published to a shopping mall of application software 10.

Here, in the embodiment, the editing components/editing tools may be PDF components, video components, slider components, MotionBox components, and/or Animation Editor. It is understood that, it depends on the actual implementation situation.

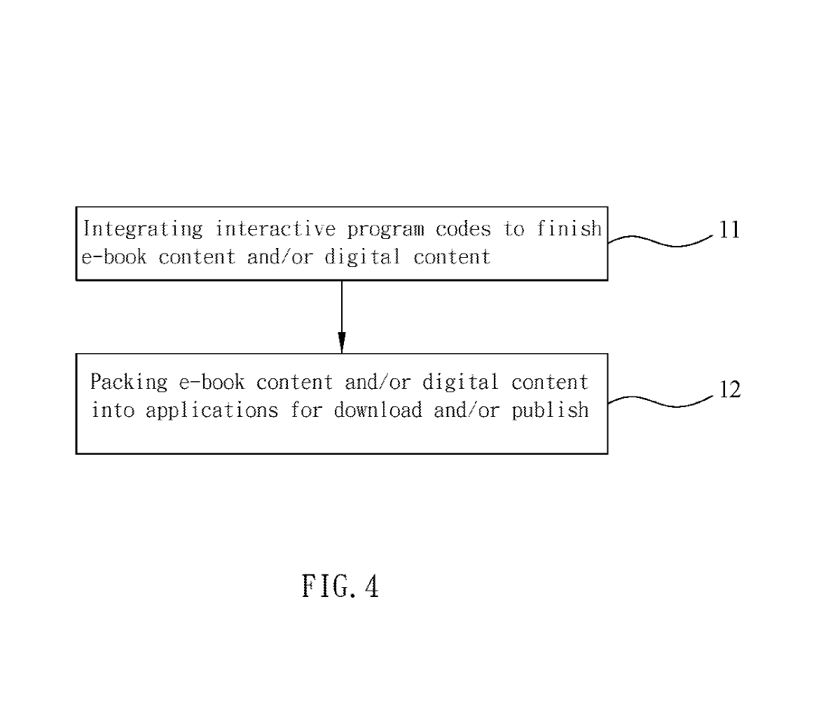

FIG. 4 is a flowchart of procedure steps of an editing method performed by the embodiment of the service system of the present invention in the FIG. 3. As shown in FIG. 4, first, in step 21, at least one user 6 selects required editing components/editing tools 511 to design e-book content 7 and/or digital content 8 using an editing interface 51 in a browser picture 5, in which various interactive program codes are automatically integrated therein, thus to efficiently finish the required e-book content 7 and/or digital content 8. The procedure goes to step 22. Here, the editing interface 51 in the browser picture 5 has a universal interactive component frame, and the editing processing module 2 presents the editing components/editing tools 511 in the editing interface 51 in the browser picture 5 on the user side 4, such that the at least one user 6 selects the required editing components/editing tools 511 to design e-book content 7 and/or digital content 8, in which various interactive program codes are automatically integrated therein, thus to efficiently finish the required e-book content 7 and/or digital content 8.

In step 22, the finished e-book content 7 and/or digital content 8 comprising interactive webpage and/or content are respectively packed into applications 71 and 81 according to the format of an operating system used for packing, wherein the packed applications 71 and 81 can be downloaded for use. Here, the editing processing module 2 packs the finished e-book content 7 and/or digital content 8 comprising interactive webpage and/or content into applications 71 and 81, wherein the packed applications 71 and 81 can be downloaded by user 6 or user 9 for use and/or published to a shopping mall of application software 10.

By synthesizing the above embodiments, editing systems and methods to be used in a digital content/e-book editing environment are provided, in which an editing interface in a use interface (for example, a browser picture) in a development platform structured on a cloud network has a universal interactive component frame. At least one user selects required editing components/editing tools to design e-book content and/or digital content, and various interactive program codes are automatically integrated, thus to efficiently finish the required e-book content and/or digital content. The finished e-book content and/or digital content comprising interactive webpage and/or content is packed into a form of application according to the format of an operating system used for packing, wherein the packed application can be downloaded for use and/or published to a shopping mall of application software. The editing systems and methods of the present invention have following advantages:

1. The editing interface in the browser picture has a universal interactive component frame, and at least one user selects required editing components/editing tools to design e-book content and/or digital content.

2. The editing interface in the browser picture can be integrated with various interactive program codes, such as HTML5, Javascript, CSS, and others, and provides an editing-friendly data uploading interface which can automatically integrated with various cool and dazzling interactive program codes, such as HTML5, Javascript, CSS, and others, thus to efficiently finish the required e-book content and/or digital content.

3. The finished e-book content and/or digital content comprising interactive webpage and/or content is packed into a form of application according to the format of an operating system used for packing, wherein the packed application can be downloaded for use.

Editing methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An editing method for use in a digital content/e-book editing environment, comprising:
selecting required editing components/editing tools from an editing interface in a use interface in a development platform structured on a cloud network by at least one user to design e-book content or digital content, in which various interactive program codes are automatically integrated therein, thus to finish the required e-book content or digital content; and
packing the finished e-book content or digital content into a form of application according to the format of an operating system used for packing.

2. The method of claim 1, wherein the e-book content or the digital content comprises interactive webpage or content.

3. The method of claim 1, wherein the use interface in the development platform structured on the cloud network is a browser picture, and the interactive program codes comprise HTML5, Javasript, or CSS.

4. An editing method for use in a digital content/e-book editing environment, comprising:
selecting required editing components/editing tools from an editing interface in a use interface in a development platform structured on a cloud network by at least one user to design e-book content or digital content, in which various interactive program codes are automatically integrated therein, thus to finish the required e-book content or digital content; and
packing the finished e-book content or digital content comprising interactive webpage or content into a form of application according to the format of an operating system used for packing, wherein the packed application are provided to download for use and/or published to a shopping mall of application software.

5. The method of claim 4, wherein the use interface in the development platform structured on the cloud network is a browser picture, and the interactive program codes comprise HTML5, Javasript, or CSS.

6. An editing method for use in a digital content/e-book editing environment, comprising:
an editing processing module presents editing components/editing tools in an editing interface in a use interface, such as a browser picture in a development platform structured on a cloud network, such that at least one user selects the required editing components/editing tools to design e-book content or digital content, in which various interactive program codes are automatically integrated therein, thus to finish the required e-book content or digital content, and packing the finished e-book content or digital content into a form of application according to the format of an operating system used for packing; and
an application database storing the packed applications corresponding to the e-book content or digital content.

7. The system of claim 6, wherein the e-book content or the digital content comprises interactive webpage or content.

8. The system of claim 6, wherein the use interface in the development platform structured on the cloud network is a browser picture, and the interactive program codes comprise HTML5, Javasript, or CSS.

9. An editing system for use in a digital content/e-book editing environment, comprising:
an editing processing module presents editing components/editing tools in an editing interface in a use interface, such as a browser picture in a development platform structured on a cloud network, such that at least one user selects the required editing components/editing tools to design e-book content or digital content, in which various interactive program codes are automatically integrated therein, thus to finish the required e-book content or digital content, packing the finished e-book content or digital content into a form of application according to the format of an operating system used for packing, and storing the packed application or publishing the packed application to a shopping mall of application software; and
an application database storing the packed applications corresponding to the e-book content or digital content.

10. The system of claim 9, wherein the use interface in the development platform structured on the cloud network is a browser picture, and the interactive program codes comprise HTML5, Javasript, or CSS.
